(19) United States
(12) Patent Application Publication
(10) Pub. No.: US 2023/0038461 A1
(43) Pub. Date: Feb. 9, 2023

(54) ASSET MANAGEMENT METHOD FOR SUBSTATION

(71) Applicant: HYOSUNG HEAVY INDUSTRIES CORPORATION, Seoul (KR)

(72) Inventors: Jae Ryong JUNG, Gimhae-si, Gyeongsangnam-do (KR); Young Min KIM, Gimhae-si, Gyeongsangnam-do (KR); Hui Seok CHAI, Gimhae-si, Gyeongsangnam-do (KR)

(21) Appl. No.: 17/792,817

(22) PCT Filed: Jan. 12, 2021
(86) PCT No.: PCT/KR2021/000374

§ 371 Date: Jul. 14, 2022

(30) Foreign Application Priority Data
Jan. 16, 2020 (KR) 10-2020-0006258

(51) Int. Cl. G06Q 10/00; G06Q 10/06

(52) U.S. Cl. CPC G06Q 10/20; G06Q 10/06316; G06Q 10/0635

(57) ABSTRACT

An asset management method for a substation in accordance with an example embodiment of the present invention comprises steps of: generating integrity of each element of the substation based on state data and real-time monitoring data of the each element of the substation; classifying grade of the each element of the substation depending on the generated integrity thereof, and matching the each element of the substation with one of life models for each classified grade; specifying a candidate element subject to maintenance in a certain order of priority, assessing system reliability index and economic feasibility, and selecting a maintenance scenario for the each candidate element subject to maintenance; and executing maintenance by using the selected maintenance scenario, and updating assessment of the integrity of the each element of the substation as a result of the maintenance executed.

### FIELD OF THE INVENTION

The present invention relates to an asset management method for a substation; and more particularly to, the asset management method that is capable of deriving an optimized management plan for each element of the substation depending on integrity of the each element of the substation.

### BACKGROUND OF THE INVENTION

In a power grid, substations are installed to increase output voltage of a generator or step up or down voltage of the grid. At a substation, devices for centralizing and distributing electricity, those for controlling the current, and those for protecting and controlling devices in a grid or substation are installed with transformers to step up or down voltage.

For example, a gas pressure sensor for measuring gas pressure, an acceleration sensor for detecting a signal due to abnormality, a current voltage detector, etc. as circuit breakers used in a gas insulated switchgear (GIS) are installed, and a thermometer, a pressure gauge, a fluid level sensor, a voltametric detector, etc., as sensors for detecting the status of a transformer, are installed in such transformer.

Such sensors are connected to protection devices, measuring devices, controllers and monitoring devices through cables transmitting electrical signals. Again, protection devices, measuring devices, controllers and monitoring devices through cables transmitting electrical signals are connected to the monitoring and controlling systems of a higher-level sub station.

Such substation has very complicated facilities to supply electricity stably, and a monitoring system which monitors the operation of a variety of devices such as circuit breakers installed in such substation to pre-detect any sign of failure to prepare for such failure or to rapidly respond to, and restore from, such failure.

In particular, in case of general electric power facilities, even though the result of integrity evaluation in time shift for the same life model has been reflected, no problem has occurred so far due to analogical characteristics. In case of calibration of an integrity evaluation-life model by using time shift, whenever maintenance is performed, the point of end of life is delayed. If maintenance is continuously applied, life does not end, which is a limitation.

Besides, as semiconductor devices such as IGBT or thyristor have been introduced to renewable energy and HVDC technology, they have digital characteristics differently from existing electric power facilities. When there have occurred any deterioration or defects in general electric power facilities, degradation and deterioration have continuously occurred so far, but when any deterioration or defects occur in facilities that have digital characteristics such as semiconductor devices, they rapidly or momentarily develop into a breakdown.

Accordingly, the need to seek for an optimized management plan even for digital electric power facilities to which semiconductor devices are applied is on rise.

### DETAILED EXPLANATION OF THE INVENTION

### Objects of the Invention

An object of the present invention is to provide an asset management method that is capable of deriving an optimized reliability model for each element of a substation by evaluating integrity of the each element of the substation.

Another object of the present invention is to provide an optimized asset management method instead of a method of delaying an end time through time shifting upon maintaining and repairing elements of substations in fields of renewable energy and HVDC that use digital equipment into which semiconductor devices such as IGBT or thyristor are introduced.

The objects of the present invention are not limited to the aforementioned objects and other objects which have not been mentioned could be clearly understood by those skilled in the art from description below.

### Means of Solving the Problem

An asset management method for a substation in accordance with the present invention comprises steps of: (a) generating integrity of each element of the substation based on state data and real-time monitoring data of the each element of the substation; (b) classifying grade of the each element of the substation depending on the generated integrity thereof, and matching the each element of the substation with one of life models for each classified grade; (c) specifying a candidate element subject to maintenance in a certain order of priority, assessing system reliability index and economic feasibility, and selecting a maintenance scenario for the each candidate element subject to maintenance; and (d) executing maintenance by using the selected maintenance scenario, and updating assessment of the integrity of the each element of the substation as a result of the maintenance executed.

Herein, at the step of (b), multiple grades may be classified depending on the generated integrity of the each element of the substation, and a different life model for each classified grade may be matched with the each element of the substation.

In addition, the life models may be established by deriving shape and scale parameter in Weibull analysis, and the life model for each grade may be established by obtaining average life model through values of shape parameter (m) and scale parameter (TO) in Weibull analysis, setting at least one of upper or lower bound of a confidence interval, and obtaining at least one of upper or lower value of the shape parameter and the scale parameter through interval estimation.

Besides, the grades may be classified into status grades which are at least two or more based on status data and real-time monitoring data on the each element of the sub station.

Furthermore, the step of (a) may include a step of generating the integrity of the each element of the substation by utilizing online, offline, and remote monitoring state data of the each element of the substation, wherein the offline monitoring state data may include at least one of data on installation history, checkup history, failure history, operating environment, and operating history of the each element of the substation.

Meanwhile, the step of (c) may include steps of (c-1) evaluating system reliability index and economic feasibility based on a life model matched with the candidate element subject to maintenance; and (c-2) selecting a maintenance scenario for the each candidate element subject to maintenance according to integrity of the each element of the substation, life model matched for the each element of the substation, and a result of the system reliability index and economic feasibility evaluated.

Moreover, the step of (a) may include a step of generating total score of, and actions against, technical risks depending on an operating environment, insulation deterioration, an electrical risk, a thermal risk, a chemical risk, a mechanical risk, airtightness performance, insulation performance, interrupting performance, and current-carrying performance of the each element of the substation.

Besides, the step of (c) may include a step of assessing customer interruption cost, energy not supplied index, sensitivity of each equipment, current value, and future value by applying failure rate, failure recovery time, load of loading point, repair costs, recovery costs, target maintenance costs, interest rate, equipment sensitivity, and parent-child relationships between the elements of the substation to the reference system reliability model.

### Effects of the Invention

In accordance with the present invention, an optimized reliability model for each element of a substation may be derived by evaluating integrity of the each element of the sub station.

The present invention may also provide calibration technology for integrity evaluation by changing a life model instead of a method of delaying a time of end through time shifting upon maintaining and repairing elements of a substation in fields of renewable energy and HVDC that use digital equipment into which semiconductor devices such as IGBT or thyristor are introduced.

The present invention has an effect of evaluating life differently depending on status by applying multiple life models in confidence interval through interval estimation, and also an effect of reflecting changing deterioration rates depending on evaluated status grades.

In addition, the present invention has an advantage of satisfying clients' requested needs of equipment replacement cycles, maintenance plans and asset management techniques

### BRIEF DESCRIPTION OF THE DRAWINGS

FIG. 1 is a flowchart to explain an asset management plan for a substation in accordance with one example embodiment of the present invention.

FIG. 2 is a chart illustrating an example of setting parameters of a life model for each element of a substation depending on each status grade through integrity evaluation in accordance with one example embodiment of the present invention.

FIG. 3 is a diagram to illustrate an example of matching and reflecting a life model depending on each status grade through integrity evaluation in accordance with one example embodiment of the present invention.

FIG. 4 is a block diagram to explain the internal structure of a substation asset management system in accordance with one example embodiment of the present invention.

### DETAILED DESCRIPTION OF THE PREFERRED EMBODIMENTS

Detailed example embodiments to implement the present invention will be explained below by referring to attached drawings.

Upon the explanation of the present invention, terms such as “a first,” “a second,” etc. may be used to explain a variety of components but the components may not be limited by such terms. The terms are used only for the purpose of distinguishing one component from another. For example, a first component may be named as a second component without being beyond the scope of the right of the present invention and similarly, even a second component may be named as a first one.

If it is mentioned that a component is connected or linked to another component, it may be understood that the component may be directly connected or linked to the another component but also a third component may exist in between them.

The terms used in this specification are used only to explain specific example embodiments and they are not intended to limit the present invention. Unless a context clearly indicates a different meaning, any reference to singular may include plural ones.

In this specification, terms such as include or equip are used to indicate that there are features, numbers, steps, operations, components, parts or combinations thereof, and it can be understood that existence or one or more different features, numbers, steps, operations, components, parts or combinations thereof are not precluded.

Besides, for clearer explanation, shapes, sizes, etc. of elements in drawings or figures may be exaggerated.

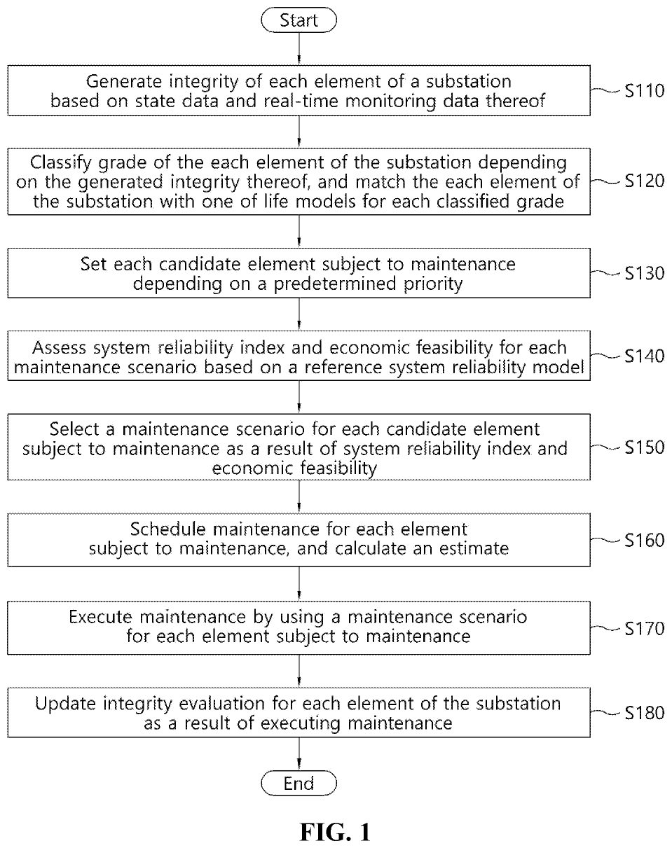

FIG. 1 is a flowchart to explain an asset management plan for a substation in accordance with one example embodiment of the present invention.

By referring to FIG. 1, a substation asset management system 100 generates integrity of each element of the substation based on state data and real-time monitoring data of the each element of the substation at S110. At the time, the state data and the real time monitoring data of the each element of the substation include online, offline, and remote monitoring state data of the each element of the substation. The offline monitoring state data may include at least one of data on installation history, checkup history, failure history, operating environment and operating history for the each element of the substation.

In addition, the substation asset management system 100 may generate total score of, and actions against, technical risks depending on an operating environment, insulation deterioration, an electrical risk, a thermal risk, a chemical risk, a mechanical risk, airtightness performance, insulation performance, interrupting performance, and current-carrying performance of the each element of the substation.

Next, the substation asset management system 100 classifies grade of each element of the substation depending on the generated integrity thereof, and reflect a life model for each element of the substation depending on the classified grade of the each element of the substation at S120.

Based on state data and real-time monitoring data of the each element of the substation in accordance with one example embodiment, grades depending on integrity of elements of the substation in accordance with the present invention may be classified into status grades containing three or more grades in accordance with an algorithm of evaluating equipment state for evaluation. In other words, the status grades may be divided into three grades: high, medium, low, or ‘good model,’ ‘cautious model,’ and ‘dangerous model.’

Meanwhile, in this example embodiment, the status grades are divided into three, but they are not limited to these. Depending on characteristics or situations, the grades may be also classified into two, or four or more.

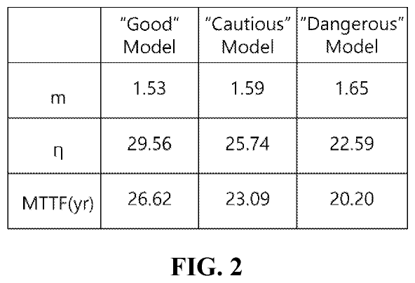

FIG. 2 is a chart illustrating an example of setting parameters of a life model for each element of a substation depending on each status grade through integrity evaluation in accordance with one example embodiment of the present invention.

As seen in FIG. 2, if there are three status grades depending on integrity evaluation, the substation asset management system 100 first obtains average life model through values of shape parameter (m) and scale parameter (η) in Weibull analysis. For example, if average life model obtains its shape parameter m of 1.59 and scale parameter η of 25.74 in Weibull analysis, the values are set as parameters falling under ‘cautious model’ which is a medium status grade.

In addition, upper and lower bounds of confidence interval for the life model are set, and an upper bound value and a lower bound value of shape parameter and scale parameter are obtained through interval estimation. For example, on assumption that the upper and lower bounds of the confidence interval for the life model are set to 95% and 85%, respectively, if the upper and lower values of each parameter are calculated, the upper and lower values of shape parameter (m) can be 1.53 and 1.65, and those of scale parameter (η) can be 29.56 and 22.59, respectively, as seen in FIG. 2. At the time, the upper values of the parameters are set as the values of the parameters for a good model among status grade models, and the lower values thereof are set as the values of the parameters for a dangerous model thereamong.

In one example embodiment in FIG. 2, it is set that m are 1.53, 1.59, and 1.65 while η are 29.56, 25.74, and 22.59 for individual status grade models. In other words, a good model has its parameter values of which m is 1.53, and η is 29.56, while a cautious model has its parameter values m and η that are 1.59, and 25.74, respectively, and a dangerous model has m and η that are 1.65, and 22.59, respectively. Besides, Mean time to Failure (MTTF) for each status grade may be calculated and used based thereon.

In accordance with the present invention, a life model for each grade may be set differently, and a different life model may be matched for a classified status grade from integrity evaluation to be used.

Meanwhile, in accordance with the example embodiment, three status grades are set to be classified depending on integrity evaluation, but they are not required to be limited to these. The status grades may be changed variously such as two, five or seven grades depending on the characteristics or situation of such element. For example, if there are two status grades classified, one of upper or lower bounds of confidence interval for a life model may be set and values of parameters corresponding thereto may be calculated. Besides, if there are five status grades classified, median value in addition to upper and lower bounds of confidence interval of the life model may be additionally set.

The present invention may provide calibration technology for integrity evaluation by changing a life model instead of using a method of delaying an end time through time shift by using the aforementioned method. It may also assess life which has different status by applying multiple life models in the confidence interval through interval estimation and reflect different deterioration rate for a status grade.

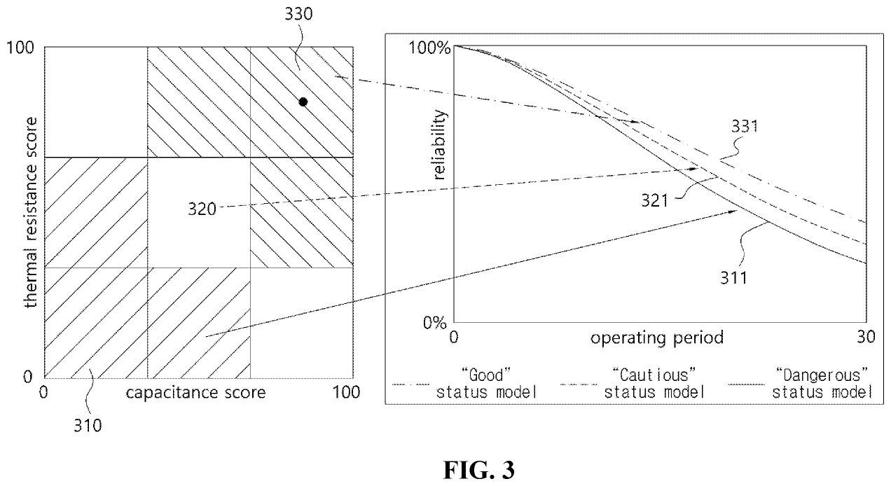

Next, the substation asset management system 100 reflects a life model responding to parameters of the life model of the element at S120. FIG. 3 is a diagram to illustrate an example of matching and reflecting a life model depending on each status grade through integrity evaluation in accordance with one example embodiment of the present invention.

By referring to FIG. 3, fixed areas based on thermal resistance score of a capacitor and thermal resistance score of an IGBT as a component of a HVDC sub module, as seen in the left diagram, may be classified into three grades, i.e., good, cautious, and dangerous grades, and a life model corresponding to each grade for each element of the substation may be matched.

For example, if a specific element of the substation falls under a section 310 in FIG. 3, a grade of the specific element would be classified as a dangerous grade, and a life model graph falling under a section 311 in the right diagram of FIG. 3 would be matched. If a specific element of the substation falls under a section 320 in FIG. 3, a grade of the specific element would be classified as a cautious grade, and a life model graph falling under 321 in the right diagram of FIG. 3 would be matched. If a specific element of the substation falls under a section 330 in FIG. 3, a grade of the specific element would be classified as a good grade, and a life model graph falling under 331 in the right diagram of FIG. 3 would be matched. In other words, for an element of the substation, a life model corresponding to a status grade classified depending on evaluated integrity of the each element would be reflected in the present invention and asset management, such as maintenance, based thereon would be executed.

Meanwhile, three status grades classified in accordance with this example embodiment were set, but they may not be limited to these. As explained above, the grades may be classified into two, four or more depending on characteristics or situation of each element. In this case, the number of life model graphs matched may be reduced or increased depending on grades.

Next, the substation asset management system 100 sets each candidate element subject to maintenance depending on a predetermined priority at S130. For example, if the predetermined priority of the substation asset management system 100 is failure rate, it is possible to set candidate elements subject to maintenance with high failure rates. In addition, other priorities may be applied under different situations.

Since then, the substation asset management system 100 assesses system reliability index and economic feasibility for each maintenance scenario based on the reflected life model for the each candidate element subject to maintenance at S140.

In accordance with one example embodiment of S140, the asset management apparatus 100 for the substation assesses customer interruption cost, energy not supplied index, sensitivity of each equipment, current value, and future value by applying failure rate, failure recovery time, load of loading point, repair costs, recovery costs, target maintenance costs, interest rate, equipment sensitivity, and parent-child relationships between the elements of the substation to the pre-generated reference system reliability model.

In addition, the substation asset management system 100 selects a maintenance scenario for the each candidate element subject to maintenance depending on the results of the integrity for the each element of the substation, the reflected life model, and the economic feasibility at S150.

In accordance with one example embodiment of S150, the substation asset management system 100 derives and selects a maintenance scenario including a maintenance strategy method, costs, and priority for each element of the substation, checkup cycle, estimated costs, checkup scheduling, and assumed maintenance effects for each element thereof, and expected replacement time for each element thereof depending on an output value for assessing reliability, an output value for technical assessment, and an output value for economic feasibility of each candidate element subject to maintenance, and cost item for maintenance checkup.

After that, the substation asset management system 100 calculates maintenance scheduling and estimate for the each candidate element subject to maintenance at S160.

Since then, maintenance is executed by using the maintenance scenario for the each candidate element subject to maintenance at S170, and the substation asset management system 100 updates evaluation of integrity of the each element of the substation as a result of the maintenance executed at S180.

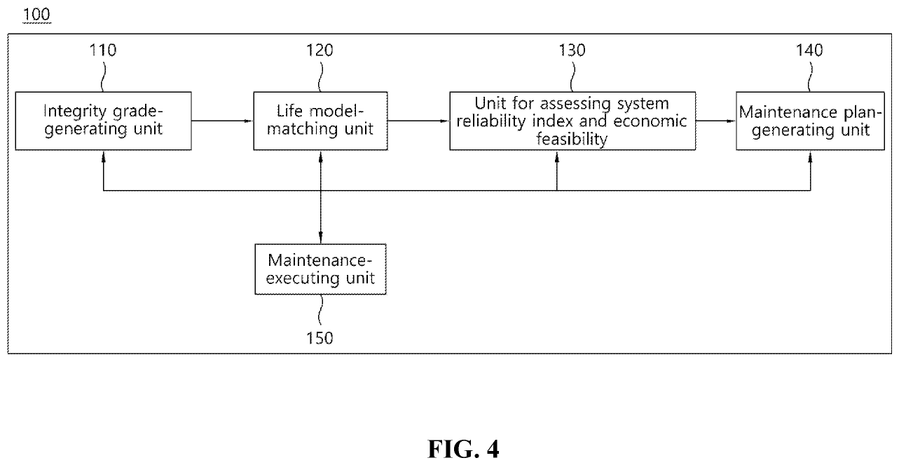

FIG. 4 is a block diagram to explain the internal structure of a substation asset management system in accordance with one example embodiment of the present invention.

By referring to FIG. 4, the substation asset management system 100 includes an integrity grade-generating unit 110, a life model-matching unit 120, a unit 130 for assessing system reliability index and economic feasibility, a maintenance plan-generating unit 140, and a maintenance-executing unit 150.

The integrity grade-generating unit 110 performs a function of generating integrity of each element of the substation based on state data and real-time monitoring data of the each element of the substation, and deriving integrity grade based thereon. At the time, state data and real-time monitoring data of each element of the substation include online, offline, and remote monitoring state data of each element of the substation. The offline monitoring state data may include at least one of data on installation history, checkup history, failure history, operating environment and operating history for each element of the sub station.

Besides, the integrity grade-generating unit 110 may generate total score of, and actions against, technical risks depending on an operating environment, insulation deterioration, an electrical risk, a thermal risk, a chemical risk, a mechanical risk, airtightness performance, insulation performance, interrupting performance, and current-carrying performance of the each element of the substation.

In accordance with one example embodiment, grades depending on integrity of elements of the substation in accordance with the present invention may be classified into status grades containing three or more grades in accordance with an algorithm of evaluating equipment state for evaluation. In other words, the status grades may be divided into three grades: high, medium, low, or ‘good model,’ ‘cautious model,’ and ‘dangerous model.’

Meanwhile, in this example embodiment, the status grades are divided into three, but they are not limited to these. Depending on characteristics or situations, the grades may be also classified into two, four or more.

The life model-matching unit 120 matches a life model depending on each status grade through evaluation of integrity. By referring to FIG. 3, the life model-matching unit 120 may classify fixed areas based on thermal resistance score of a capacitor and thermal resistance score of an IGBT as a component of a HVDC sub module, as seen in the left diagram, into three grades, i.e., good, cautious, and dangerous grades, and match a life model corresponding to each grade.

For example, if a specific element of the substation falls under a section 310 in FIG. 3, a grade of the specific element would be classified as a dangerous grade, and a life model graph falling under a section 311 in the right diagram of FIG. 3 would be matched. If a specific element of the substation falls under a section 320 in FIG. 3, a grade of the specific element would be classified as a cautious grade, and a life model graph falling under 321 in the right diagram of FIG. 3 would be matched. If a specific element of the substation falls under a section 330 in FIG. 3, a grade of the specific element would be classified as a good grade, and a life model graph falling under 331 in the right diagram of FIG. 3 would be matched. In other words, for an element of the substation, a life model corresponding to a status grade classified depending on evaluated integrity of the each element would be reflected in the present invention and asset management, such as maintenance, based thereon would be executed.

Meanwhile, three status grades classified in accordance with this example embodiment were set, but they may not be limited to these. As explained above, the grades may be classified into two, four or more depending on characteristics or situation of an element. In this case, the number of life model graphs matched may be reduced or increased depending on grades.

After setting each candidate element subject to maintenance among the elements of the substation depending on a predetermined priority, the unit 130 for assessing system reliability index and economic feasibility assesses system reliability index and economic feasibility for each maintenance scenario based on the reflected life model for the each candidate element subject to maintenance.

After applying failure rate, failure recovery time, load of loading point, repair costs, recovery costs, target maintenance costs, interest rate, equipment sensitivity, and parent-child relationships between the elements of the substation to the pre-generated reference system reliability model, the unit 130 for assessing system reliability index and economic feasibility in accordance with one example embodiment of the present invention assesses customer interruption cost, energy not supplied index, sensitivity of each equipment, current value, and future value.

The maintenance plan-generating unit 140 selects a maintenance scenario for the each candidate element subject to maintenance depending on the results of the integrity for the each element of the substation, the reflected life model, and the economic feasibility.

In accordance with one example embodiment of the present invention, the maintenance plan-generating unit 140 derives and selects a maintenance scenario for each candidate element subject to maintenance, including a maintenance strategy method, costs, and priority for each element of the substation, checkup cycle, estimated costs, checkup scheduling, and assumed maintenance effects for each element thereof, and expected replacement time for each element thereof depending on an output value for assessing reliability, an output value for technical assessment, and an output value for economic feasibility of maintenance scenario, and cost items for maintenance checkup.

The maintenance-executing unit 150 updates evaluated integrity of the each element of the substation as the result of executing the maintenance under the maintenance scenario for the each element subject to maintenance selected by the maintenance plan-generating unit 140.

As explained above, the present invention may provide calibration technology for integrity evaluation by changing a life model instead of a method of delaying an end time through time shifting upon maintaining and repairing elements of substations in fields of renewable energy and HVDC that use digital equipment into which semiconductor devices, such as IGBT or thyristor, are introduced. In addition, the present invention has an effect of evaluating life differently depending on status by applying multiple life models in confidence interval through interval estimation, and also an effect of reflecting changing deterioration rates depending on evaluated status grades.

As seen above, the present invention has been explained by limited example embodiments and drawings but it is not limited to the example embodiments. Various changes and modifications may be derived from those skilled in the art. Accordingly, the invention must be identified by the claims of the present invention as described below and all variables and equivalents would appertain to the scope of the ideas of the present invention.

### REFERENCE NUMERALS

100: Substation asset management system
110: integrity grade-generating unit
120: Life model-matching unit
130: Unit for assessing system reliability index and economic feasibility
140: Maintenance plan-generating unit
150: Maintenance-executing unit

### INDUSTRIAL AVAILABILITY

The present invention relates to an asset management method for a substation and is available in a field of substation.

What is claimed is:

1. An asset management method for a substation, comprising steps of:
(a) generating integrity of each element of the substation based on state data and real-time monitoring data of the each element of the substation;
(b) classifying grade of the each element of the substation depending on the generated integrity thereof, and matching the each element of the substation with one of life models for each classified grade;
(c) specifying a candidate element subject to maintenance in a certain order of priority, assessing system reliability index and economic feasibility, and selecting a maintenance scenario for the each candidate element subject to maintenance; and
(d) executing maintenance by using the selected maintenance scenario, and updating assessment of the integrity of the each element of the substation as a result of the maintenance executed.

2. The method of claim 1, wherein, at the step of (b), multiple grades are classified depending on the generated integrity of the each element of the substation, and a different life model for each classified grade is matched with the each element of the substation.

3. The method of claim 2, wherein the life models are established by deriving shape and scale parameter in Weibull analysis, and the life model for each grade is established by obtaining average life model through values of shape parameter (m) and scale parameter (ii) in Weibull analysis, setting at least one of upper or lower bound of a confidence interval, and obtaining at least one of upper or lower value of the shape parameter and the scale parameter through interval estimation.

4. The method of claim 2, wherein the grades are classified into status grades which are at least two or more based on status data and real-time monitoring data on the each element of the substation.

5. The method of claim 1, wherein the step of (a) includes a step of generating the integrity of the each element of the substation by utilizing online, offline, and remote monitoring state data of the each element of the substation, wherein the offline monitoring state data includes at least one of data on installation history, checkup history, failure history, operating environment, and operating history of the each element of the substation.

6. The method of claim 1, wherein the step of (c) includes steps of (c-1) evaluating system reliability index and economic feasibility based on a life model matched with the candidate element subject to maintenance; and (c-2) selecting a maintenance scenario for the each candidate element subject to maintenance according to integrity of the each element of the substation, life model matched for the each element of the substation, and a result of the system reliability index and economic feasibility evaluated.

7. The method of claim 1, wherein the step of (a) includes a step of generating total score of, and actions against, technical risks depending on an operating environment, insulation deterioration, an electrical risk, a thermal risk, a chemical risk, a mechanical risk, airtightness performance, insulation performance, interrupting performance, and current-carrying performance of the each element of the substation.

8. The method of claim 1, wherein the step of (c) includes a step of assessing customer interruption cost, energy not supplied index, sensitivity of each equipment, current value, and future value by applying failure rate, failure recovery time, load of loading point, repair costs, recovery costs, target maintenance costs, interest rate, equipment sensitivity, and parent-child relationships between the elements of the substation to the reference system reliability model.
